(19) United States
(12) Patent Application Publication
(10) Pub. No.: US 2024/0397360 A1
(43) Pub. Date: Nov. 28, 2024

(54) MEASURING CALL SET UP TIME AT UE

(71) Applicant: Telefonaktiebolaget LM Ericsson (publ), Stockholm (SE)

(72) Inventors: Mats STILLE, Bromma (SE); Anders Sivert Michael ANEHILL, Sollentuna (SE); Robert JANSSON, Huddinge (SE)

(21) Appl. No.: 18/686,054

(22) PCT Filed: Aug. 24, 2021
(86) PCT No.: PCT/EP2021/073405

§ 371 Date: Feb. 23, 2024

(51) Int. Cl. H04W 24/10

(52) U.S. Cl. CPC H04W 24/10

(57) ABSTRACT

Embodiments herein disclose, for example, a method performed by a radio network node for communicating or handling communication in a wireless communication network. The radio network node transmits an indication requesting a UE to perform a measurement of a call setup time for the UE in the wireless communication network and/or to provide a value of the measurement to the radio network node.

### CROSS REFERENCE TO RELATED APPLICATIONS

This application is a 35 U.S.C. § 371 national stage application of PCT International Application No. PCT/EP2021/073405 filed on Aug. 24, 2021, the disclosure and content of which is incorporated by reference herein in its entirety.

### TECHNICAL FIELD

Embodiments herein relate to a radio network node, a user equipment (UE), and methods performed therein regarding communication in a wireless communication network. Furthermore, a computer program product and a computer-readable storage medium are also provided herein. Especially, embodiments herein relate to handling or enabling communication in the wireless communication network.

### BACKGROUND

In a typical wireless communication network, UEs, also known as wireless communication devices, mobile stations, stations (STA) and/or wireless devices, communicate via a Radio access Network (RAN) to one or more core networks (CN). The RAN covers a geographical area which is divided into service areas or cell areas, with each service area or cell area being served by a radio network node such as an access node e.g. a Wi-Fi access point or a radio base station (RBS), which in some radio access technologies (RAT) may also be called, for example, a NodeB, an evolved NodeB (eNodeB) and a gNodeB (gNB). The service area or cell area is a geographical area where radio coverage is provided by the radio network node. The radio network node operates on radio frequencies to communicate over an air interface with the UEs within range of the access node. The radio network node communicates over a downlink (DL) to the UE and the UE communicates over an uplink (UL) to the radio network node. The radio network node may be a distributed node comprising a remote radio unit and a separated baseband unit.

A Universal Mobile Telecommunications System (UMTS) is a third generation telecommunication network, which evolved from the second generation (2G) Global System for Mobile Communications (GSM). The UMTS terrestrial radio access network (UTRAN) is essentially a RAN using wideband code division multiple access (WCDMA) and/or High-Speed Packet Access (HSPA) for communication with UEs. In a forum known as the Third Generation Partnership Project (3GPP), telecommunications suppliers propose and agree upon standards for present and future generation networks, and investigate enhanced data rate and radio capacity. In some RANs, e.g. as in UMTS, several radio network nodes may be connected, e.g., by landlines or microwave, to a controller node, such as a radio network controller (RNC) or a base station controller (BSC), which supervises and coordinates various activities of the plural radio network nodes connected thereto. The RNCs are typically connected to one or more core networks.

Specifications for the Evolved Packet System (EPS) have been completed within the 3rd Generation Partnership Project (3GPP) and also for fifth generation (5G) networks. The EPS comprises the Evolved Universal Terrestrial Radio Access Network (E-UTRAN), also known as the Long-Term Evolution (LTE) radio access network, and the Evolved Packet Core (EPC), also known as System Architecture Evolution (SAE) core network. E-UTRAN/LTE is a 3GPP radio access technology wherein the radio network nodes are directly connected to the EPC core network. As such, the Radio Access Network (RAN) of an EPS has an essentially “flat” architecture comprising radio network nodes connected directly to one or more core networks.

With the emerging 5G technologies also known as new radio (NR), the use of very many transmit- and receive-antenna elements makes it possible to utilize beamforming, such as transmit-side and receive-side beamforming. Transmit-side beamforming means that the transmitter can amplify the transmitted signals in a selected direction or directions, while suppressing the transmitted signals in other directions. Similarly, on the receive-side, a receiver can amplify signals from a selected direction or directions, while suppressing unwanted signals from other directions.

The Internet Protocol (IP) Multimedia Subsystem (IMS) is a well-known Third Generation Partnership Project (3GPP) standard allowing sessions to be set up between two or more parties for a broad variety of services such as voice or video call, interactive messaging sessions or third-party specific applications. A few common enablers are defined by 3GPP for common usage among all these services. Examples of such enablers are capability discovery and subscribing to conference events to be used by for example an ad-hoc voice call conference for clients/devices to identify who leaves and enters the conference.

The signalling protocol chosen by 3GPP is the Session Initiation Protocol (SIP). SIP is an application layer protocol used for controlling multimedia sessions over IP networks. It is a text-based protocol which uses a request/response model. SIP defines messages sent between endpoints, which govern establishment, termination and other essential elements of a multimedia connection. SIP can be used for creating, modifying and terminating sessions consisting of one or more media streams. It can be both unicast and multicast. Examples of applications which SIP can establish, and control are video conferencing, streaming multimedia distribution, instant messaging, presence information, file transfer, fax over IP and online games.

### SUMMARY

As a part of developing embodiments herein a problem was first identified and will be discussed herein. Presently one may request a number of measurements to be performed by a UE to handle communications in a wireless communication network, and an originated call setup time can today be retrieved through operator management systems, from IMS. However, the retrieved call setup time reflects the network call setup time, i.e., the time from an IMS proxy-Call Session Control Function (P-CSCF) network function (NF) sends an SIP INVITE until message “SIP 180” ringing is received. It does not cover the call setup time over the access, from UE to network.

A problem an operator has in order to trace e.g. malfunctioning UEs or wants to optimize radio environment, is that there is no information available from the UE about how long the call setup time is from a UE perspective, i.e. the time it takes for the UE call client, using Voice over NR (VoNR) which is the 3GPP solution for Voice over 5GS or Voice over LTE (VOLTE), to receive a SIP 180, or SIP 200 in case SIP 180 is not received at all, after having sent a SIP INVITE. Thus, leading to a limited performance of the wireless communication network.

An object of embodiments herein is to provide a mechanism that improves performance of the wireless communication network.

According to an aspect the object is achieved by providing a method performed by a radio network node for handling communication of a UE in a wireless communication network. The radio network node transmits to the UE an indication, wherein the indication requests a measurement indicating a call setup time for the UE in the wireless communication network and/or to provide a value of the measurement to the radio network node. For example, adding an option in the existing list of measurements items, 3GPP TS 32.422 v.17.0.0 section 5.10.3 ‘List of measurements’, that the radio network node may order a UE to measure on, indicating a new measurement item denoted as ‘Call setup time’.

According to another aspect the object is achieved by providing a method performed by a UE for handling communication of the UE in a wireless communication network. The UE receives an indication from a radio network node, wherein the indication requests a measurement indicating a call setup time for the UE in the wireless communication network and/or to provide a value of the measurement to the radio network node. The UE measures the call setup time and may report the same to the radio network node.

It is furthermore provided herein a computer program product comprising instructions, which, when executed on at least one processor, cause the at least one processor to carry out any of the methods above, as performed by the radio network node or the UE, respectively. It is additionally provided herein a computer-readable storage medium, having stored thereon a computer program product comprising instructions which, when executed on at least one processor, cause the at least one processor to carry out the method according to any of the methods above, as performed by the radio network node or the UE, respectively.

According to still another aspect the object is achieved by providing a radio network node for handling communication of a UE in a wireless communication network. The radio network node is configured to transmit an indication to the UE, wherein the indication requests a measurement indicating a call setup time for the UE in the wireless communication network and/or to provide a value of the measurement to the radio network node.

According to yet still another aspect the object is achieved by providing a UE for handling communication of the UE in a wireless communication network. The UE is configured to receive an indication from a radio network node, wherein the indication requests a measurement indicating a call setup time for the UE in the wireless communication network and/or to provide a value of the measurement to the radio network node. The UE is configured to measure the call setup time and may be configured to report the measured call setup time to the radio network node.

Embodiments herein relate to methods and apparatuses for initiating retrieval of the call setup time for the UE. This may provide the operator to get a powerful tool by providing the UE experienced call setup time which can be used to mitigate problems with long call setup times, minimizing the need for cumbersome UE drive tests. Hence, embodiments herein improve communication in the wireless communication network.

### BRIEF DESCRIPTION OF DRAWINGS

Embodiments will now be described in more detail in relation to the enclosed drawings, in which:

FIG. 1 shows a schematic overview depicting a wireless communication network according to embodiments herein.

FIG. 2 shows a combined signalling scheme and flowchart according to embodiments herein.

FIG. 3 shows a schematic flowchart depicting a method performed by a radio network node according to embodiments herein.

FIG. 4 shows a schematic flowchart depicting a method performed by a UE according to embodiments herein.

FIG. 5 shows a block diagram depicting radio network nodes according to embodiments herein.

FIG. 6 shows a block diagram depicting UEs according to embodiments herein.

FIG. 7 schematically illustrates a telecommunication network connected via an intermediate network to a host computer.

FIG. 8 is a generalized block diagram of a host computer communicating via a base station with a user equipment over a partially wireless connection.

FIGS. 9-12 are flowcharts illustrating methods implemented in a communication system including a host computer, a base station and a user equipment.

### DETAILED DESCRIPTION

Embodiments herein are described in the context of 5G/NR and LTE but the same concept can also be applied to other wireless communication system such UMTS. Embodiments herein may be described within the context of 3GPP NR radio technology, e.g. using gNB as the radio network node. It is understood, that the problems and solutions described herein are equally applicable to wireless access networks and UEs implementing other access technologies and standards. NR is used as an example technology where embodiments are suitable, and using NR in the description therefore is particularly useful for understanding the problem and solutions solving the problem. In particular, embodiments are applicable also to 3GPP LTE, or 3GPP LTE and NR integration, also denoted as non-standalone NR.

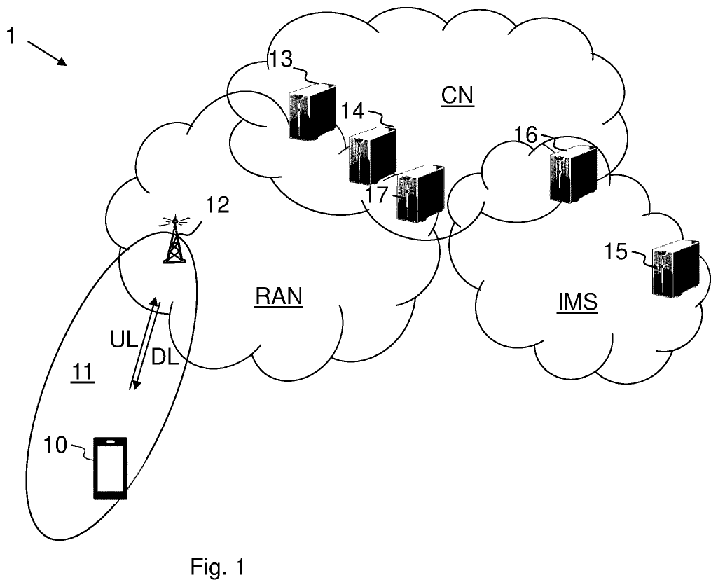

Embodiments herein relate to wireless communications networks in general. FIG. 1 is a schematic overview depicting a wireless communications network 1. The wireless communications network 1 comprises one or more RANs and one or more CNs. The wireless communications network 1 may use one or a number of different technologies. Embodiments herein relate to recent technology trends that are of particular interest in a NR context, however, embodiments are also applicable in further development of existing wireless communications systems such as e.g. LTE or WCDMA.

In the wireless communications network 1, a UE 10, exemplified herein as a wireless device such as a mobile station, a non-access point (non-AP) station (STA), a STA and/or a wireless terminal, is comprised communicating via e.g. one or more Access Networks (AN), e.g. RANs, to one or more CNs. It should be understood by the skilled in the art that “UE” is a non-limiting term which means any terminal, wireless communications terminal, user equipment, narrowband internet of things (NB-IoT) device, Machine Type Communication (MTC) device, Device to Device (D2D) terminal, or node e.g. smart phone, laptop, mobile phone, sensor, relay, mobile tablets or even a small base station capable of communicating using radio communication with a radio network node within an area served by the radio network node.

The wireless communications network 1 comprises a radio network node 12 providing radio coverage over a geographical area, a first service area 11 or first cell, of a first RAT, such as NR, LTE, or similar. The radio network node 12 may be a transmission and reception point such as an access node, an access controller, a base station, e.g. a radio base station such as a gNodeB (gNB), an evolved Node B (eNB, eNode B), a NodeB, a base transceiver station, a radio remote unit, an Access Point Base Station, a base station router, a Wireless Local Area Network (WLAN) access point or an Access Point Station (AP STA), a transmission arrangement of a radio base station, a stand-alone access point or any other network unit or node capable of communicating with a wireless device within the area served by the radio network node 12 depending e.g. on the first radio access technology and terminology used. The radio network node 12 may be referred to as a serving radio network node wherein the service area may be referred to as a serving cell, and the serving network node communicates with the UE 10 in form of DL transmissions to the UE 10 and UL transmissions from the UE 10. It should be noted that a service area may be denoted as cell, beam, beam group or similar to define an area of radio coverage.

The wireless communication network provides IMS services, such as voice over LTE (VOLTE), voice over NR (VoNR), or similar, and comprises a first IMS node 15 and a second IMS node 16 of an IMS. The first IMS node 15 may be an application server provided by an IMS provider. The second IMS node 16 may be a Home Subscriber Server (HSS) or a Call Session Control Function (CSCF) node such as a P-CSCF or a S-CSCF node. The Call session control function e.g. facilitates Session Internet Protocol (SIP) setup and teardown and the HSS plays the role of a location server in IMS, in addition to acting as an authentication, authorization, accounting (AAA) server. The CSCF may comprise one or more of distributed functions e.g. a proxy CSCF node (P-CSCF), an Interrogating CSCF (I-CSCF) node, and a Serving CSCF (S-CSCF) node. The P-CSCF acts as the entry point in the IMS network. The HSS is the main database of the current generation's cellular communications systems. It contains subscriber-related information, such as the authentication information and the list of services to which each user is subscribed.

As stated above the communication network comprises a number of core network nodes providing network functions (NF), such as a first network node 13 for example an Access and Mobility Management Function (AMF) and a second network node 14 such as a user plane function (UPF), and a third network node 17 such as a network repository function (NRF), or any other network function in the wireless communication network 1.

According to embodiments herein the radio network node 12 transmits an indication to the UE 10, wherein the indication indicates a retrieval of a value of a measurement or indicates the measurement to be performed by the UE 10, for example, when the UE 10 is using an IMS service such as VOLTE. The measurement defines a call setup time for the UE 10 in the wireless communication network 1. This measured call setup time may then be used by an operator or similar to improve communication in the wireless communication network 1.

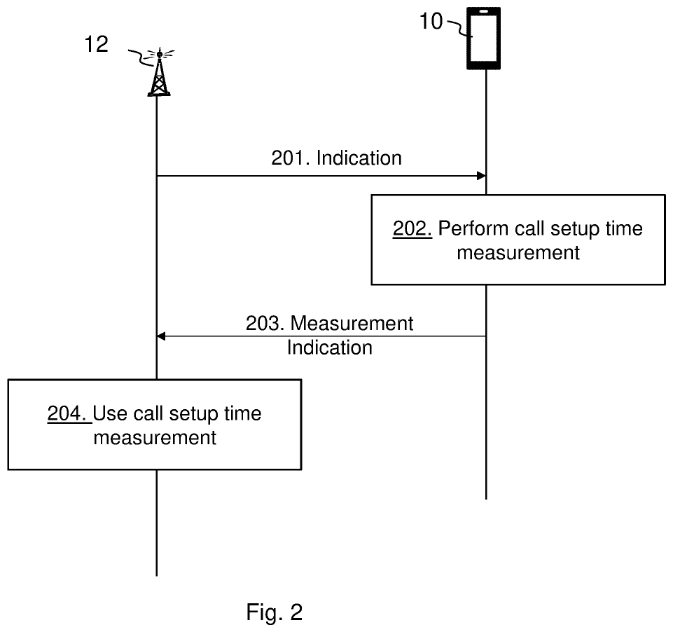

FIG. 2 is a combined signalling scheme and flowchart according to embodiments herein. In this example the UE 10 is connected to the first cell 11.

Action 201. The radio network node 12 transmits the indication requesting the UE 10 to perform a measurement of the call setup time for the UE 10 in the wireless communication network 1 and/or to provide the value of the measurement to the radio network node 12. The indication may be a real value or a flag or an index. For example, the radio network node 12 may transmit a measurement list to the UE 10, wherein the measurement list comprises the indication. Furthermore, the radio network node 12 may transmit a reporting indication indicating a method to report the measurement to the radio network node 12. The indication and the reporting indication may be transmitted in a same message or different messages.

The measurement list to the UE 10 may be expressed by 4 octets. Bits are reserved for the existing measurements M1 to M9 as of 3GPP TS 32.422 section 5.10.3 v.17.0.0 and any of spare values can be used to indicating call setup time measurement. For example, bit 2 of the 2nd octet can be reserved for ‘Call setup time’. Bit 3 can indicate reporting method where 0 means same method used by M1-M9 e.g. the UEinformationresponse message (TS 36.331 § 6.2.2), and 1 means SIP call control method. The latter implies that the UE 10 reports the call setup time in a new SIP header of the SIP BYE message, if UE releases the call before remote side, or the SIP 200 OK message, if the remote side released the call before the UE 10. The former implies that the UEInformationResonse message referred to above, is extended with a new ASN1 data about call setup time, and new field description is added such as:

### Callsetuptime:

Indicates the absolute time between the UE sent a call invitation request SIP INVITE until it received a call ringing indication SIP 180 (or 200 (INVITE) in case network skips sending SIP 180).

Action 202. The UE 10 performs the measurement. The UE 10 may measure time between a sent call initiation message, for example, a sent call indication request (SIP INVITE), and receiving a received request indication such as the SIP 180 or SIP 200. SIP 180 is a message used to alert the caller that the user agent (UA) receiving the SIP INVITE is ringing, and SIP 200 is an indication that the SIP invite has been received. It should here be noted that the measurement may be performed before receiving the indication, for example, in the case when the indication indicates a retrieval of the measurement. It should further be noted that the measurement of the call setup time may be a part of a minimization drive test (MDT) process and the indication may trigger immediate MDT but also of logged MDT, when the UE 10 in idle mode.

Action 203. The UE 10 may then transmit to the radio network node 12, a measurement indication indicating the measured call setup time. For example, the UE 10 may transmit a SIP message with a measurement value, e.g., a new SIP header of the SIP BYE message, the SIP 200 OK or a SIP CANCEL message in which the UE can include the call set up time, and transmit to the network. Use case for the UE 10 sending SIP CANCEL is when a user makes a call (SIP INVITE), it gets ringing (SIP 180), but the user on hooks (SIP CANCEL) due to that the user gets tired waiting for the called party to answer. It should here be noted that the UE may be given the indication not only in the context of immediate measurement but also of a logged measurement, for example, when the UE in idle mode, see 32.422 v.16.0.0 section 5.10.27. Thus, the measurement may be triggered and/or retrieved by the indication.

Action 204. The reported call setup time may then be used by the radio network node 12 or another network node to handle upcoming calls and/or communication in the wireless communication network. For example, the call setup time may be used to trace malfunctioning UEs or to optimize radio environment.

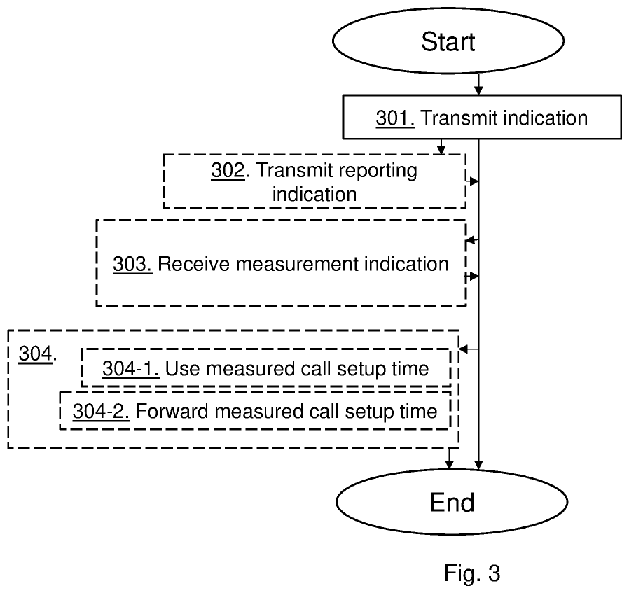

The method actions performed by the radio network node 12 for communicating or handling communication in the wireless communication network according to embodiments will now be described with reference to a flowchart depicted in FIG. 3. The actions do not have to be taken in the order stated below, but may be taken in any suitable order. Actions performed in some embodiments are marked with dashed boxes.

Action 301. The radio network node 12 transmits to the UE 10 the indication requesting the UE 10 to perform the measurement of the call setup time for the UE 10 and/or to provide the value of the measurement to the radio network node 12. The measurement may be based on sent and received SIP messages. The indication may be a real value or a flag or an index. For example, the radio network node 12 may transmit a measurement list to the UE 10, wherein the measurement list comprises the indication. The indication may be same or separate values for indicating retrieval and performance of the measurement.

Action 302. Furthermore, the radio network node 12 may transmit a reporting indication indicating method to report the measurement to the radio network node 12. The indication and the reporting indication may be transmitted in a same message or different messages.

In TS 32.422 v.17.0.0. section 5.10.3 it is stated.

### 5.10.3 List of Measurements

This parameter is mandatory if the Job type is configured for Immediate MDT or combined Immediate MDT and Trace. This parameter defines the measurements that shall be collected. For further details see also TS 37.320 [30]. The parameter is 4 octet long bitmap with the following values in UMTS:
M1: CPICH RSCP and CPICH Ec/No measurement by UE with Periodic or event IF as reporting triggers.
M2: For 1.28 Meps TDD, P-CCPCH RSCP and Timeslot ISCP measurement by UE with event 1I as reporting triggers.
M3: SIR and SIR error (FDD) by NodeB
M4: UE power headroom (UPH) by the UE, applicable for E-DCH transport channels.
M5: Received total wideband power (RTWP) by Node B
M6: Data Volume measurement, separately for DL and UL, by RNC.
M7: Throughput measurement, separately for DL and UL, per RAB and per UE, by RNC.
Any combination of the above
   The parameter can have the following values in LTE:
M1: RSRP, RSRQ and SINR measurement by UE with Periodic, event A2 as reporting triggers
M2: Power Headroom (PH) measurement by UE
NOTE: Available from MAC layer
M3: Received Interference Power measurement by eNB
M4: Data Volume measurement separately for DL and UL by eNB.
M5: Scheduled IP Throughput measurement separately for DL and UL, per RAB per UE and per UE for the DL, per UE for the UL, by eNB
M6: Packet Delay measurement, separately for DL and UL, per QCI per UE, UL PDCP Delay, by the UE, and Packet Delay in the DL per QCI, by the eNB
M7: Packet Loss rate measurement, separately for DL and UL per QCI per UE, by the eNB
M8: RSSI measurement by UE for WLAN and Bluetooth®.
M9: RTT measurement by UE only for WLAN
And any combination of above
   The parameter can have the following values in NR:
M1: DL signal quantities measurement results for the serving cell and for intra-frequency/Inter-frequency/inter-RAT neighbour cells, including cell/beam level measurement.
M2: Power headroom (PH) measurement by UE
M3 is not supported by this release
M4: Data volume measurement separately for DL and UL
M5: Average UE throughput measurement separately for DL and UL
M6: Packet delay measurement, separately for DL and UL.
M7: Packet loss rate measurement, separately for DL and UL.
M8: RSSI measurement by UE for WLAN and Bluetooth®.M9: RTT measurement by UE for WLAN
   Detailed information for M4, M5, M6, M7 is defined 3GPP TS 36.314 [35], for M1, M8, M9 in 3GPP TS 38.331 [43], for M2 in TS 38.321 [51].

| | | | | | | | |
|---|---|---|---|---|---|---|---|
| Bit 8 | Bit 7 | Bit 6 | Bit 5 | Bit 4 | Bit 3 | Bit 2 | Bit 1 |

LTE

| | | | | | | | |
|---|---|---|---|---|---|---|---|
| M7 | M6 | logging of M1 from | M5 | M4 | M3 | M2 | M1 |
| | | event triggered | | | | | |
| | | measurement | | | | | |
| | | reports according | | | | | |
| | | to existing RRM | | | | | |
| | | configuration | | | | | |

spare
UMTS

| | | | | | | | |
|---|---|---|---|---|---|---|---|
| M7 for DL | M6 for UL | M6 for DL | M5 | M4 | M3 | M2 | M1 |

| spare | M7 for |
|---|---|
| | UL |

The measurement list to the UE 10 may be expressed by 4 octets. Bits are reserved for the existing measurements M1 to M9 as of 3GPP TS 32.422 section 5.10.3 v.17.0.0 and any of spare values can be used to indicating call setup time measurement, i.e. the indication. For example, bit 2 of the 2nd octet can be reserved for ‘Call setup time’.

Furthermore, as stated above the reporting indication may be comprised in the same message. For example, Bit 3 may indicate reporting method where 0 may mean same method used by M1-M9, e.g., the UEinformationresponse message (TS 36.331 v.17.0.0 section 6.2.2), and 1 may mean SIP call control method. The latter implies that the UE 10 reports the call setup time in a new SIP header of the SIP BYE message, if UE releases the call before remote side, or the SIP 200 OK message, if the remote side released the call before the UE 10. The former implies that the UEInformationResonse message referred to above, is extended with a new ASN1 data about call setup time, and new field description is added such as:

### Callsetuptime

Indicates the absolute time between the UE sent a call invitation request SIP INVITE until it received a call ringing indication SIP 180, or 200 (INVITE) in case network skips sending SIP 180.

Action 303. The radio network node 12 may then receive the measurement indication from the UE 10 reporting the measured call setup time. The measurement indication may be a real value, a relative value or similar. The measurement indication may be received in a message related to the method as indicated by the reporting indication.

Action 304. The radio network node 12 may then further use the indicated measured call setup time for handling communication in the wireless communication network (304-1). The radio network node 12 may additionally or alternatively, forward the indicated measured call setup time to another network node for handling communication in the wireless communication network (304-2).

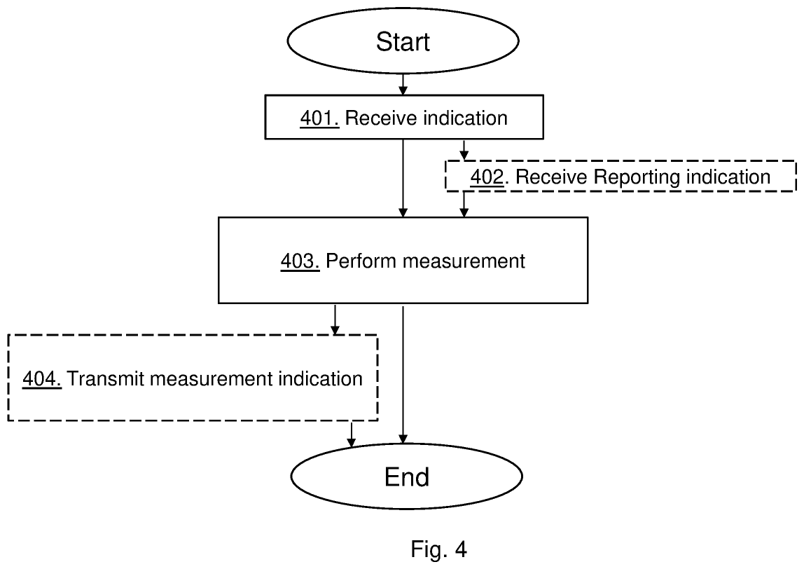

The method actions performed by the UE 10 for communicating in the wireless communication network according to embodiments will now be described with reference to a flowchart depicted in FIG. 4. The actions do not have to be taken in the order stated below, but may be taken in any suitable order. Actions performed in some embodiments are marked with dashed boxes.

Action 401. The UE 10 receives from the radio network node 12 the indication requesting the UE 10 to perform the measurement of the call setup time for the UE 10 and/or to provide the value of the measurement to the radio network node. The indication may be a real value or a flag or an index. For example, the UE 10 may receive the measurement list from the radio network node 12, wherein the measurement list comprises the indication. Thus, the indication may be for triggering the measurement, e.g., an immediate measurement or a measurement later in idle mode, and/or the indication may be for retrieving an already recorded measurement.

Action 402. Furthermore, the UE 10 may receive from the radio network node 12, the reporting indication indicating the method to report the measurement of the call setup time to the radio network node 12. The indication and the reporting indication may be received in a same message or different messages. The way of reporting the measurement of the call setup time may be preconfigured at the UE 10.

Action 403. The UE 10 measures the call setup time of a call from the UE 10 such as a VOLTE call or a VoNR call. The measurement may be based on sent and received SIP messages. Thus, the UE 10 may measure time between a sent call initiation message, for example, a sent call indication request such as an SIP INVITE, and receiving a received request indication such as the SIP 180 or SIP 200. The measurements may be triggered by receiving the indication from the radio network node 12 or may be preconfigured at the UE 10 and then retrieved by the radio network node 12. Thus, action 403 may be performed before action 401.

Action 404. The UE 10 may then report the measured call setup time to the radio network node 12. The UE 10 may transmit the measurement indication to the radio network node 12 reporting the measured call setup time. The measurement indication may be a real value, a relative value or similar. The measurement indication may be transmitted in a message related to the method as indicated by the reporting indication. For example, the UE 10 may transmit a SIP message with a measurement value, e.g., a new SIP header of the SIP BYE message, the SIP 200 OK or a SIP CANCEL message. Thus, a SIP header in which the UE can include the call set up time, and transmit to the network. As an option, the UE 10 may transmit this measurement indication based on an internal pre-configuration trigger.

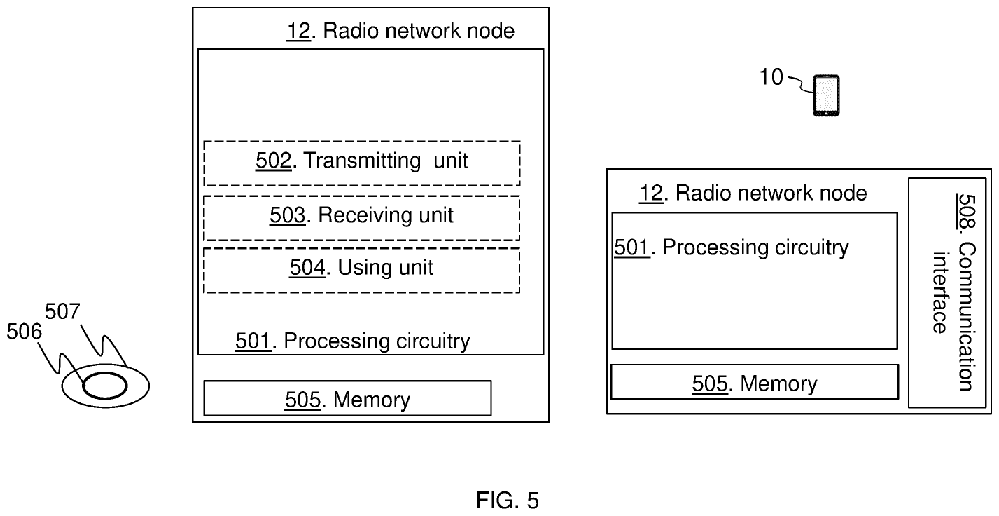

FIG. 5 is a block diagram depicting the radio network node 12, in two embodiments, for communicating or handling communication in the wireless communication network 1 according to embodiments herein.

The radio network node 12 may comprise processing circuitry 501, e.g. one or more processors, configured to perform the methods herein.

The radio network node 12 may comprise a transmitting unit 502, e.g., a transmitter or a transceiver. The radio network node 12, the processing circuitry 501 and/or the transmitting unit 502 is configured to transmit to the UE 10, the indication requesting the UE 10 to perform the measurement of the call setup time for the UE 10 in the wireless communication network and/or to provide the value of the measurement to the radio network node 12. The indication may be a real value or a flag or an index. For example, the radio network node 12, the processing circuitry 501 and/or the transmitting unit 502 may be configured to transmit the measurement list to the UE 10, wherein the measurement list comprises the indication. Furthermore, the radio network node 12, the processing circuitry 501 and/or the transmitting unit 502 may be configured to transmit the reporting indication indicating the method to report the measurement to the radio network node 12. The indication and the reporting indication may be transmitted in a same message or different messages. The measurement may be based on sent and received SIP messages.

The radio network node 12 may comprise a receiving unit 503, e.g., a receiver or a transceiver. The radio network node, the processing circuitry 501 and/or the receiving unit 503 may be configured to receive the measurement indication from the UE 10 reporting the measured call setup time. The measurement indication may be a real value, a relative value or similar. The measurement indication may be received in a message related to the method as indicated by the reporting indication.

The radio network node 12 may comprise a using unit 504. The radio network node 12, the processing circuitry 501 and/or the using unit 504 may be configured to use the indicated measured call setup time for handling communication in the wireless communication network, or forward the indicated measured call setup time to another network node for handling communication in the wireless communication network.

The radio network node 12 further comprises a memory 505. The memory comprises one or more units to be used to store data on, such as indications, reporting indications, measurement indications, time values, time intervals, call setup times, strengths or qualities, grants, messages, execution conditions, user data, reconfiguration, configurations, scheduling information, timers, applications to perform the methods disclosed herein when being executed, and similar. The radio network node 12 comprises a communication interface 508 comprising transmitter, receiver, transceiver and/or one or more antennas.

The methods according to the embodiments described herein for the radio network node 12 are respectively implemented by means of, e.g., a computer program product 506 or a computer program product, comprising instructions, i.e., software code portions, which, when executed on at least one processor, cause the at least one processor to carry out the actions described herein, as performed by the radio network node 12. The computer program product 506 may be stored on a computer-readable storage medium 507, e.g. a universal serial bus (USB) stick, a disc or similar. The computer-readable storage medium 507, having stored thereon the computer program product, may comprise the instructions which, when executed on at least one processor, cause the at least one processor to carry out the actions described herein, as performed by the radio network node 12. In some embodiments, the computer-readable storage medium may be a non-transitory or transitory computer-readable storage medium. Thus, it is herein disclosed a radio network node for handling communication in a wireless communication network, wherein the radio network node comprises processor circuitry and a memory for storing instructions executable by said processor circuitry, and whereby the processing circuitry is operative to perform a method according to any of the embodiments above as performed by the radio network node.

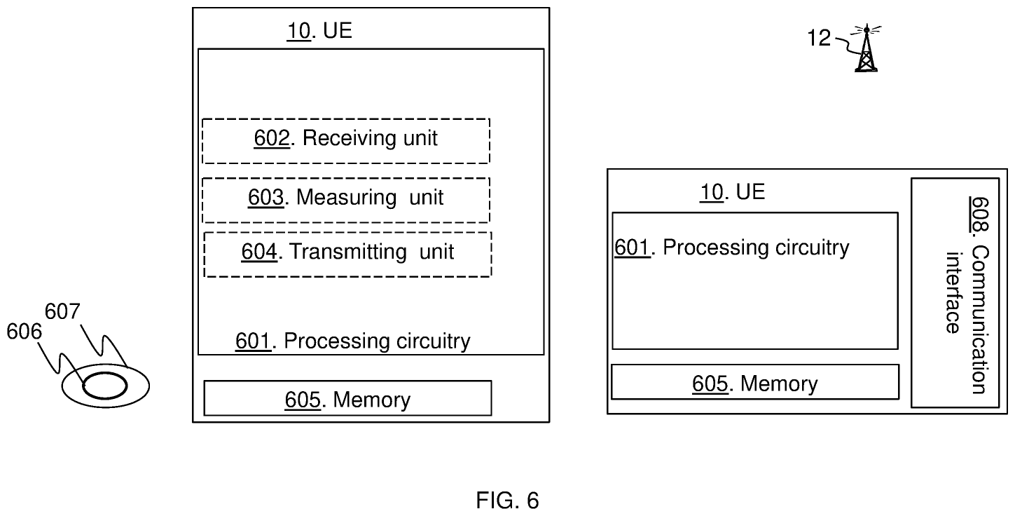

FIG. 6 is a block diagram depicting the UE 10, in two embodiments, for communicating or handling communication in the wireless communication network 1 according to embodiments herein.

The UE 10 may comprise processing circuitry 601, e.g., one or more processors, configured to perform the methods herein.

The UE 10 may comprise a receiving unit 602, e.g., a receiver and/or transceiver. The UE 10, the processing circuitry 601 and/or the receiving unit 602 is configured to receive from the radio network node 12 the indication requesting the UE 10 to perform the measurement of the call setup time for the UE 10 and/or to provide the value of the measurement to the radio network node 12. The indication may be a real value or a flag or an index. The UE 10, the processing circuitry 601 and/or the receiving unit 602 may be configured to receive the measurement list from the radio network node 12, wherein the measurement list comprises the indication. Furthermore, the UE 10, the processing circuitry 601 and/or the receiving unit 602 may be configured to receive from the radio network node, the reporting indication indicating the method to report the measurement of the call setup time to the radio network node 12. The indication and the reporting indication may be received in a same message or different messages. The way of reporting the measurement of the call setup time may be preconfigured at the UE 10.

The UE 10 may comprise a measuring unit 603. The UE 10, the processing circuitry 601 and/or the measuring unit 603 is configured to measure the call setup time of a call from the UE such as a VOLTE call or a VoNR call. The measurement may be based on sent and received SIP messages. The UE 10, the processing circuitry 601 and/or the measuring unit 603 may be configured to measure the time between the sent call initiation message, for example, a sent call indication request such as an SIP INVITE, and receiving the received request indication such as the SIP 180 or SIP 200.

The UE 10 may comprise a transmitting unit 604, e.g., a transmitter and/or transceiver. The UE 10, the processing circuitry 601 and/or the transmitting unit 604 may be configured to transmit the measurement indication to the radio network node 12 reporting the measured call setup time. The measurement indication may be a real value, a relative value or similar. The measurement indication may be transmitted in a message related to the method as indicated by the reporting indication. Thus, the UE 10, the processing circuitry 601 and/or the transmitting unit 604 may be configured to report the measured call setup time to the radio network node 12. The UE 10, the processing circuitry 601 and/or the transmitting unit 604 may be configured to transmit the measurement indication in a SIP message such as a measurement value in, e.g., a new SIP header of the SIP BYE message, the SIP 200 OK or a SIP CANCEL message.

The UE 10 further comprises a memory 605. The memory comprises one or more units to be used to store data on, such as indications, reporting indications, measurement values, measurement indications, time intervals, strengths or qualities, grants, indications, reconfiguration, configuration, values, scheduling information, timers, applications to perform the methods disclosed herein when being executed, and similar. The UE 10 comprises a communication interface 608 comprising transmitter, receiver, transceiver and/or one or more antennas.

The methods according to the embodiments described herein for the UE 10 are respectively implemented by means of e.g. a computer program product 606 or a computer program product, comprising instructions, i.e., software code portions, which, when executed on at least one processor, cause the at least one processor to carry out the actions described herein, as performed by the UE 10. The computer program product 606 may be stored on a computer-readable storage medium 607, e.g. a universal serial bus (USB) stick, a disc or similar. The computer-readable storage medium 607, having stored thereon the computer program product, may comprise the instructions which, when executed on at least one processor, cause the at least one processor to carry out the actions described herein, as performed by the UE 10. In some embodiments, the computer-readable storage medium may be a non-transitory or transitory computer-readable storage medium. Thus, it is herein disclosed a UE for handling communication in a wireless communication network, wherein the UE comprises processor circuitry and a memory for storing instructions executable by said processor circuitry, and whereby the processing circuitry is operative to perform a method according to any of the embodiments above as performed by the UE.

In some embodiments a more general term “radio network node” is used and it can correspond to any type of radio network node or any network node, which communicates with a wireless device and/or with another network node. Examples of network nodes are NodeB, Master eNB, Secondary eNB, a network node belonging to Master cell group (MCG) or Secondary Cell Group (SCG), base station (BS), multi-standard radio (MSR) radio node such as MSR BS, eNodeB, network controller, radio network controller (RNC), base station controller (BSC), relay, donor node controlling relay, base transceiver station (BTS), access point (AP), gateways, transmission points, transmission nodes, Remote Radio Unit (RRU), Remote Radio Head (RRH), nodes in distributed antenna system (DAS), core network node e.g. Mobility Switching Centre (MSC), Mobile Management Entity (MME) etc., Operation and Maintenance (O&M), Operation Support System (OSS), Self-Organizing Network (SON), positioning node e.g. Evolved Serving Mobile Location Centre (E-SMLC), Minimizing Drive Test (MDT) etc.

In some embodiments the non-limiting term wireless device or user equipment (UE) is used and it refers to any type of wireless device communicating with a network node and/or with another UE in a cellular or mobile communication system. Examples of UE are target device, device-to-device (D2D) UE, proximity capable UE (aka ProSe UE), machine type UE or UE capable of machine to machine (M2M) communication, PDA, PAD, Tablet, mobile terminals, smart phone, laptop embedded equipped (LEE), laptop mounted equipment (LME), USB dongles etc.

The embodiments are described for 5G. However the embodiments are applicable to any RAT or multi-RAT systems, where the UE receives and/or transmit signals (e.g. data) e.g. LTE, LTE FDD/TDD, WCDMA/HSPA, GSM/GERAN, Wi Fi, WLAN, CDMA2000 etc.

As will be readily understood by those familiar with communications design, that functions means or modules may be implemented using digital logic and/or one or more microcontrollers, microprocessors, or other digital hardware. In some embodiments, several or all of the various functions may be implemented together, such as in a single application-specific integrated circuit (ASIC), or in two or more separate devices with appropriate hardware and/or software interfaces between them. Several of the functions may be implemented on a processor shared with other functional components of a wireless device or network node, for example.

Alternatively, several of the functional elements of the processing means discussed may be provided through the use of dedicated hardware, while others are provided with hardware for executing software, in association with the appropriate software or firmware. Thus, the term “processor” or “controller” as used herein does not exclusively refer to hardware capable of executing software and may implicitly include, without limitation, digital signal processor (DSP) hardware, read-only memory (ROM) for storing software, random-access memory for storing software and/or program or application data, and non-volatile memory. Other hardware, conventional and/or custom, may also be included. Designers of communications devices will appreciate the cost, performance, and maintenance trade-offs inherent in these design choices.

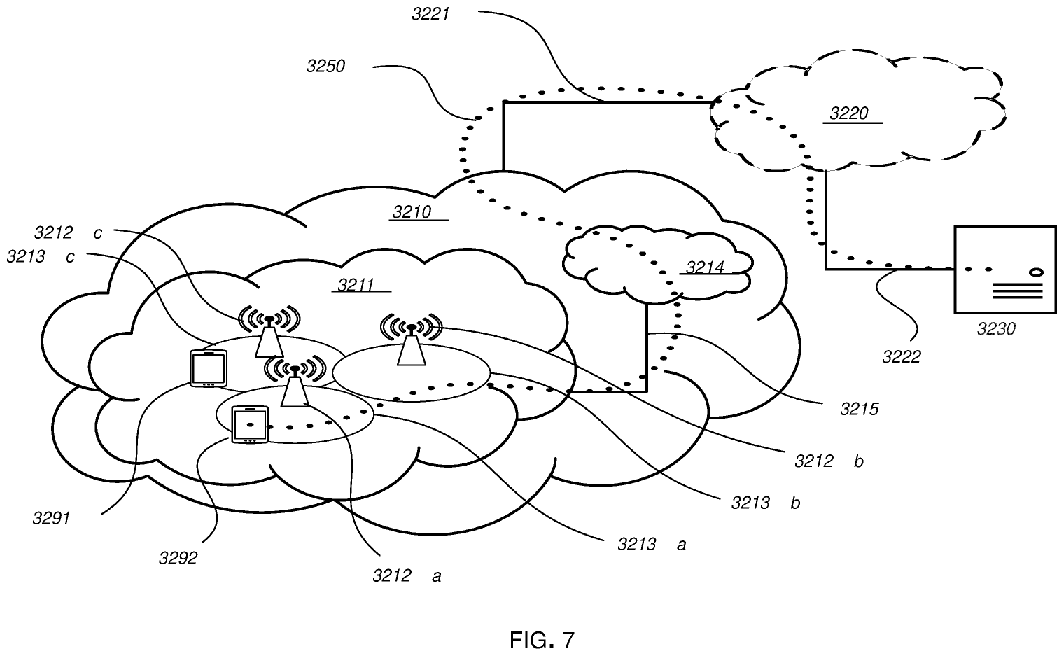

With reference to FIG. 7, in accordance with an embodiment, a communication system includes a telecommunication network 3210, such as a 3GPP-type cellular network, which comprises an access network 3211, such as a radio access network, and a core network 3214. The access network 3211 comprises a plurality of base stations 3212a, 3212b, 3212c, such as NBs, eNBs, gNBs or other types of wireless access points being examples of the radio network nodes herein, each defining a corresponding coverage area 3213a, 3213b, 3213c. Each base station 3212a, 3212b, 3212c is connectable to the core network 3214 over a wired or wireless connection 3215. A first user equipment (UE) 3291, being an example of the UE 10, located in coverage area 3213c is configured to wirelessly connect to, or be paged by, the corresponding base station 3212c. A second UE 3292 in coverage area 3213a is wirelessly connectable to the corresponding base station 3212a. While a plurality of UEs 3291, 3292 are illustrated in this example, the disclosed embodiments are equally applicable to a situation where a sole UE is in the coverage area or where a sole UE is connecting to the corresponding base station 3212.

The telecommunication network 3210 is itself connected to a host computer 3230, which may be embodied in the hardware and/or software of a standalone server, a cloud-implemented server, a distributed server or as processing resources in a server farm. The host computer 3230 may be under the ownership or control of a service provider, or may be operated by the service provider or on behalf of the service provider. The connections 3221, 3222 between the telecommunication network 3210 and the host computer 3230 may extend directly from the core network 3214 to the host computer 3230 or may go via an optional intermediate network 3220. The intermediate network 3220 may be one of, or a combination of more than one of, a public, private or hosted network; the intermediate network 3220, if any, may be a backbone network or the Internet; in particular, the intermediate network 3220 may comprise two or more sub-networks (not shown).

The communication system of FIG. 7 as a whole enables connectivity between one of the connected UEs 3291, 3292 and the host computer 3230. The connectivity may be described as an over-the-top (OTT) connection 3250. The host computer 3230 and the connected UEs 3291, 3292 are configured to communicate data and/or signaling via the OTT connection 3250, using the access network 3211, the core network 3214, any intermediate network 3220 and possible further infrastructure (not shown) as intermediaries. The OTT connection 3250 may be transparent in the sense that the participating communication devices through which the OTT connection 3250 passes are unaware of routing of uplink and downlink communications. For example, a base station 3212 may not or need not be informed about the past routing of an incoming downlink communication with data originating from a host computer 3230 to be forwarded (e.g., handed over) to a connected UE 3291. Similarly, the base station 3212 need not be aware of the future routing of an outgoing uplink communication originating from the UE 3291 towards the host computer 3230.

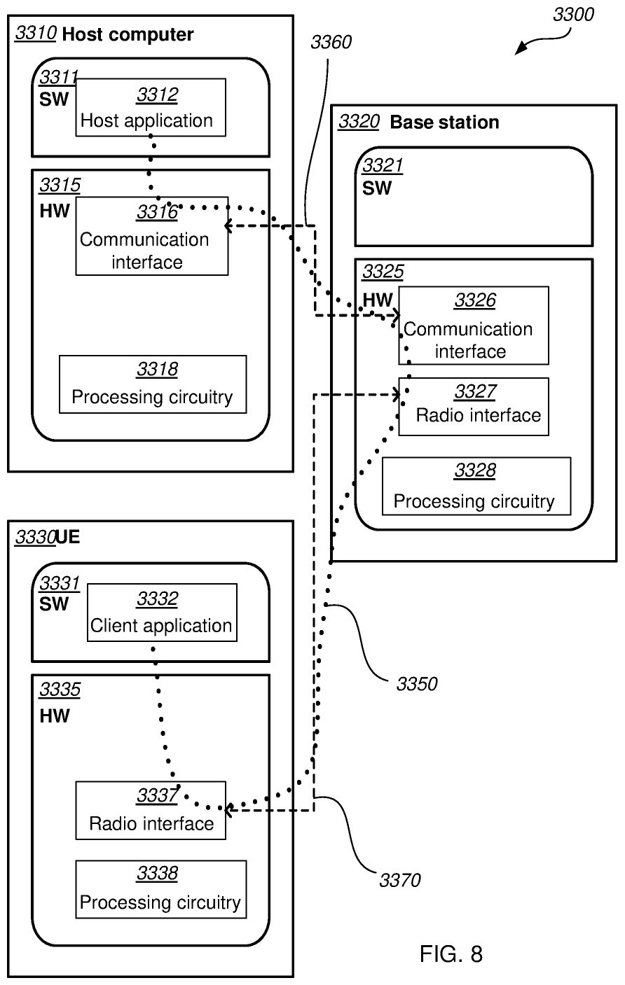

Example implementations, in accordance with an embodiment, of the UE, base station and host computer discussed in the preceding paragraphs will now be described with reference to FIG. 8. In a communication system 3300, a host computer 3310 comprises hardware 3315 including a communication interface 3316 configured to set up and maintain a wired or wireless connection with an interface of a different communication device of the communication system 3300. The host computer 3310 further comprises processing circuitry 3318, which may have storage and/or processing capabilities. In particular, the processing circuitry 3318 may comprise one or more programmable processors, application-specific integrated circuits, field programmable gate arrays or combinations of these (not shown) adapted to execute instructions. The host computer 3310 further comprises software 3311, which is stored in or accessible by the host computer 3310 and executable by the processing circuitry 3318. The software 3311 includes a host application 3312. The host application 3312 may be operable to provide a service to a remote user, such as a UE 3330 connecting via an OTT connection 3350 terminating at the UE 3330 and the host computer 3310. In providing the service to the remote user, the host application 3312 may provide user data which is transmitted using the OTT connection 3350.

The communication system 3300 further includes a base station 3320 provided in a telecommunication system and comprising hardware 3325 enabling it to communicate with the host computer 3310 and with the UE 3330. The hardware 3325 may include a communication interface 3326 for setting up and maintaining a wired or wireless connection with an interface of a different communication device of the communication system 3300, as well as a radio interface 3327 for setting up and maintaining at least a wireless connection 3370 with a UE 3330 located in a coverage area (not shown in FIG. 8) served by the base station 3320. The communication interface 3326 may be configured to facilitate a connection 3360 to the host computer 3310. The connection 3360 may be direct or it may pass through a core network (not shown in FIG. 8) of the telecommunication system and/or through one or more intermediate networks outside the telecommunication system. In the embodiment shown, the hardware 3325 of the base station 3320 further includes processing circuitry 3328, which may comprise one or more programmable processors, application-specific integrated circuits, field programmable gate arrays or combinations of these (not shown) adapted to execute instructions. The base station 3320 further has software 3321 stored internally or accessible via an external connection.

The communication system 3300 further includes the UE 3330 already referred to. Its hardware 3335 may include a radio interface 3337 configured to set up and maintain a wireless connection 3370 with a base station serving a coverage area in which the UE 3330 is currently located. The hardware 3335 of the UE 3330 further includes processing circuitry 3338, which may comprise one or more programmable processors, application-specific integrated circuits, field programmable gate arrays or combinations of these (not shown) adapted to execute instructions. The UE 3330 further comprises software 3331, which is stored in or accessible by the UE 3330 and executable by the processing circuitry 3338. The software 3331 includes a client application 3332. The client application 3332 may be operable to provide a service to a human or non-human user via the UE 3330, with the support of the host computer 3310. In the host computer 3310, an executing host application 3312 may communicate with the executing client application 3332 via the OTT connection 3350 terminating at the UE 3330 and the host computer 3310. In providing the service to the user, the client application 3332 may receive request data from the host application 3312 and provide user data in response to the request data. The OTT connection 3350 may transfer both the request data and the user data. The client application 3332 may interact with the user to generate the user data that it provides.

It is noted that the host computer 3310, base station 3320 and UE 3330 illustrated in FIG. 8 may be identical to the host computer 3230, one of the base stations 3212a, 3212b, 3212c and one of the UEs 3291, 3292 of FIG. 7, respectively. This is to say, the inner workings of these entities may be as shown in FIG. 8 and independently, the surrounding network topology may be that of FIG. 7.

In FIG. 8, the OTT connection 3350 has been drawn abstractly to illustrate the communication between the host computer 3310 and the user equipment 3330 via the base station 3320, without explicit reference to any intermediary devices and the precise routing of messages via these devices. Network infrastructure may determine the routing, which it may be configured to hide from the UE 3330 or from the service provider operating the host computer 3310, or both. While the OTT connection 3350 is active, the network infrastructure may further take decisions by which it dynamically changes the routing (e.g., on the basis of load balancing consideration or reconfiguration of the network).

The wireless connection 3370 between the UE 3330 and the base station 3320 is in accordance with the teachings of the embodiments described throughout this disclosure. One or more of the various embodiments improve the performance of OTT services provided to the UE 3330 using the OTT connection 3350, in which the wireless connection 3370 forms the last segment. More precisely, the teachings of these embodiments may enable tracing malfunctioning UEs and/or communication performance and thereby provide benefits such as improved user experience and better responsiveness.

A measurement procedure may be provided for the purpose of monitoring data rate, latency and other factors on which the one or more embodiments improve. There may further be an optional network functionality for reconfiguring the OTT connection 3350 between the host computer 3310 and UE 3330, in response to variations in the measurement results. The measurement procedure and/or the network functionality for reconfiguring the OTT connection 3350 may be implemented in the software 3311 of the host computer 3310 or in the software 3331 of the UE 3330, or both. In embodiments, sensors (not shown) may be deployed in or in association with communication devices through which the OTT connection 3350 passes; the sensors may participate in the measurement procedure by supplying values of the monitored quantities exemplified above, or supplying values of other physical quantities from which software 3311, 3331 may compute or estimate the monitored quantities. The reconfiguring of the OTT connection 3350 may include message format, retransmission settings, preferred routing etc.; the reconfiguring need not affect the base station 3320, and it may be unknown or imperceptible to the base station 3320. Such procedures and functionalities may be known and practiced in the art. In certain embodiments, measurements may involve proprietary UE signaling facilitating the host computer's 3310 measurements of throughput, propagation times, latency and the like. The measurements may be implemented in that the software 3311, 3331 causes messages to be transmitted, in particular empty or ‘dummy’ messages, using the OTT connection 3350 while it monitors propagation times, errors etc.

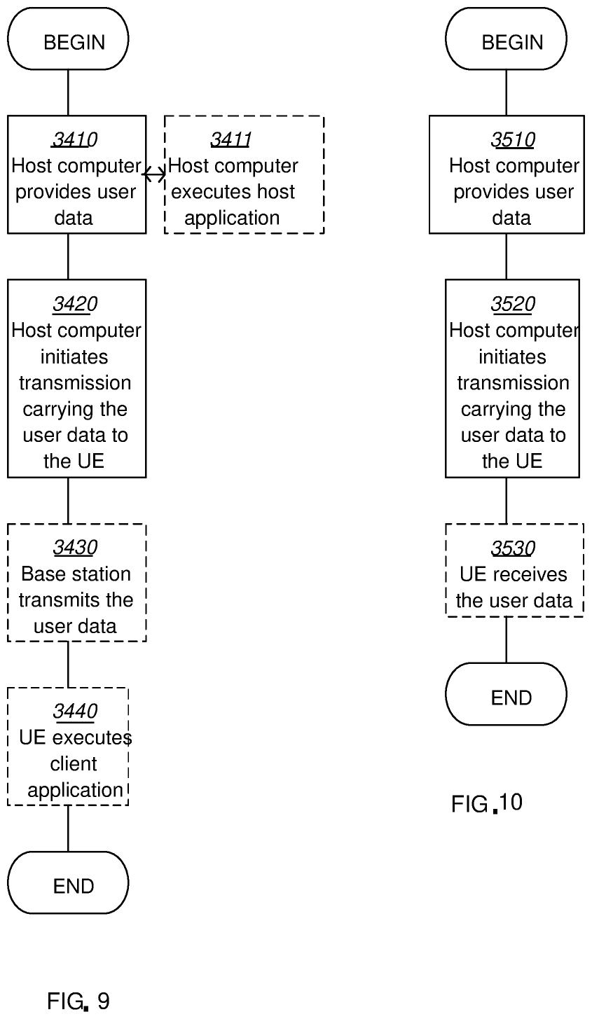

FIG. 9 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 9 will be included in this section. In a first step 3410 of the method, the host computer provides user data. In an optional substep 3411 of the first step 3410, the host computer provides the user data by executing a host application. In a second step 3420, the host computer initiates a transmission carrying the user data to the UE. In an optional third step 3430, the base station transmits to the UE the user data which was carried in the transmission that the host computer initiated, in accordance with the teachings of the embodiments described throughout this disclosure. In an optional fourth step 3440, the UE executes a client application associated with the host application executed by the host computer.

FIG. 10 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 10 will be included in this section. In a first step 3510 of the method, the host computer provides user data. In an optional substep (not shown) the host computer provides the user data by executing a host application. In a second step 3520, the host computer initiates a transmission carrying the user data to the UE. The transmission may pass via the base station, in accordance with the teachings of the embodiments described throughout this disclosure. In an optional third step 3530, the UE receives the user data carried in the transmission.

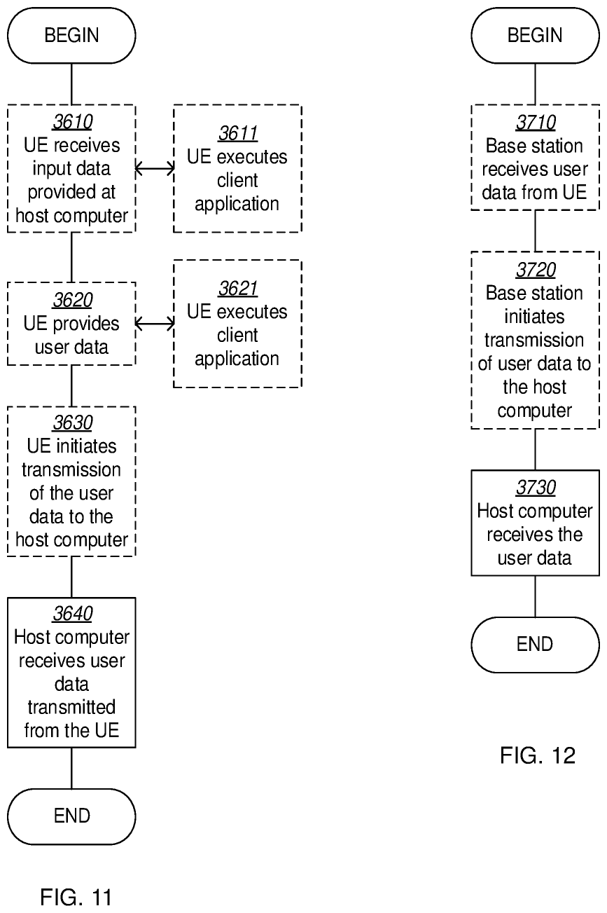

FIG. 11 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 11 will be included in this section. In an optional first step 3610 of the method, the UE receives input data provided by the host computer. Additionally or alternatively, in an optional second step 3620, the UE provides user data. In an optional substep 3621 of the second step 3620, the UE provides the user data by executing a client application. In a further optional substep 3611 of the first step 3610, the UE executes a client application which provides the user data in reaction to the received input data provided by the host computer. In providing the user data, the executed client application may further consider user input received from the user. Regardless of the specific manner in which the user data was provided, the UE initiates, in an optional third substep 3630, transmission of the user data to the host computer. In a fourth step 3640 of the method, the host computer receives the user data transmitted from the UE, in accordance with the teachings of the embodiments described throughout this disclosure.

FIG. 12 is a flowchart illustrating a method implemented in a communication system, in accordance with one embodiment. The communication system includes a host computer, a base station and a UE which may be those described with reference to FIGS. 7 and 8. For simplicity of the present disclosure, only drawing references to FIG. 12 will be included in this section. In an optional first step 3710 of the method, in accordance with the teachings of the embodiments described throughout this disclosure, the base station receives user data from the UE. In an optional second step 3720, the base station initiates transmission of the received user data to the host computer. In a third step 3730, the host computer receives the user data carried in the transmission initiated by the base station.

It will be appreciated that the foregoing description and the accompanying drawings represent non-limiting examples of the methods and apparatus taught herein. As such, the apparatus and techniques taught herein are not limited by the foregoing description and accompanying drawings. Instead, the embodiments herein are limited only by the following claims and their legal equivalents.

1. A method performed by a radio network node for handling communication in a wireless communication network, comprising:
transmitting to a user equipment, UE, an indication requesting the UE to perform a measurement of a call setup time for the UE in the wireless communication network and/or to provide a value of the measurement to the radio network node.

2. The method of claim 1, wherein transmitting the indication comprises transmitting a measurement list to the UE, wherein the measurement list comprises the indication.

3. The method of claim 1, further comprising:
transmitting a reporting indication indicating a method to report the measurement to the radio network node.

4. The method according to claim 1, wherein the measurement is based on sent and received session initiation protocol, SIP, messages.

5. The method according to claim 1, further comprising:
receiving a measurement indication from the UE reporting the measured call setup time.

6. The method according to claim 3, wherein the measurement indication is received in a message related to the method as indicated by the reporting indication.

7. The method according to claim 1, further comprising:
using the indicated measured call setup time for handling communication in the wireless communication network, or forwarding the indicated measured call setup time to another network node for handling communication in the wireless communication network

8. A method performed by a user equipment, UE, for handling communication in a wireless communication network, the method comprising:
receiving from a radio network node, an indication requesting the UE to perform a measurement of a call setup time for the UE in the wireless communication network and/or to provide a value of the measurement to the radio network node, and
measuring the call setup time of a call from the UE.

9. The method according to claim 8, further comprising:
transmitting a measurement indication to the radio network node reporting the measured call setup time.

10. The method according to claim 8, further comprising:
receiving from the radio network node, a reporting indication indicating a method to report the measurement of the call setup time to the radio network node.

11. The method according to claim 9, wherein the measurement indication is transmitted in a message related to the method as indicated by the reporting indication.

12. The method according to claim 8, wherein measuring the call setup time comprises measuring time between a sent call initiation message, and a received request indication.

13. The method according to claim 9, wherein receiving the indication comprises receiving a measurement list from the radio network node, wherein the measurement list comprises the indication.

14. The method according to claim 8, wherein the measurement is based on sent and received session initiation protocol, SIP, messages.

15.-18. (canceled)

19. A radio network node for handling communication in a wireless communication network, wherein the radio network node comprises: processor circuitry and a memory for storing instructions executable by said processor circuitry, and whereby the processing circuitry is operative to transmit to a user equipment, UE, an indication requesting the UE to perform a measurement of a call setup time for the UE in the wireless communication network and/or to provide a value of the measurement to the radio network node.

20. A user equipment, UE, for handling communication in a wireless communication network, wherein the UE comprises: processor circuitry and a memory for storing instructions executable by said processor circuitry, and whereby the processing circuitry is operative to receive from a radio network node an indication requesting the UE to perform a measurement of a call setup time for the UE in the wireless communication network, and configured to measure the call setup time of a call from the UE and/or to provide a value of the measurement to the radio network node.

21. The radio network node according to the claim 19, wherein transmit the indication comprises transmitting a measurement list to the UE, wherein the measurement list comprises the indication.

22. The radio network according to claim 19, wherein the processing circuitry is further operative to transmit a reporting indication indicating a method to report the measurement to the radio network node.

23. The UE according to claim 20, wherein the processing circuitry is further operative to transmit a measurement indication to the radio network node reporting the measured call setup time.

24. The UE according to claim 20, wherein the processing circuitry is further operative to receive from the radio network node, a reporting indication indicating a method to report the measurement of the call setup time to the radio network node.
